(19) United States
(12) Patent Application Publication
(10) Pub. No.: US 2024/0115929 A1
(43) Pub. Date: Apr. 11, 2024

(54) MULTIPLICATION TABLE CARD GAME

(71) Applicant: Alexandre MOREIRA DE MENEZES, Aracaju/SE (BR)

(72) Inventor: Alexandre MOREIRA DE MENEZES, Aracaju/SE (BR)

(21) Appl. No.: 18/275,102

(22) PCT Filed: Sep. 30, 2021
(86) PCT No.: PCT/BR2021/050423

§ 371 Date: Jul. 31, 2023

(30) Foreign Application Priority Data
Feb. 2, 2021 (BR) 10 2021 001942 5

(51) Int. Cl. A63F 1/02; G09B 19/22

(52) U.S. Cl. CPC A63F 1/02; G09B 19/22

(57) ABSTRACT

The present invention patent application for the claimed multiplication table card game relates to a card game for two or more players. Recommended for children aged 6 to 11 years. The multiplication table card game is an educational mathematics game for children who are beginning to study multiplication tables and who need to quickly calculate a multiplication table if they have forgotten a previously memorized multiplication table. The multiplication table card game provides players or students with an alternative for resolving the multiplication table by calculating the multiplication mentally. It contains 64 cards. Each card shows a multiplication operation with a suggested solution. The players set a time for each round of questions according to the game rules. The game demystifies and facilitates multiplication tables for children. The multiplication table card game is a simple game that can be used in any school in any country to incentivize the learning of multiplication tables, and can also be played at home for learning and leisure purposes.

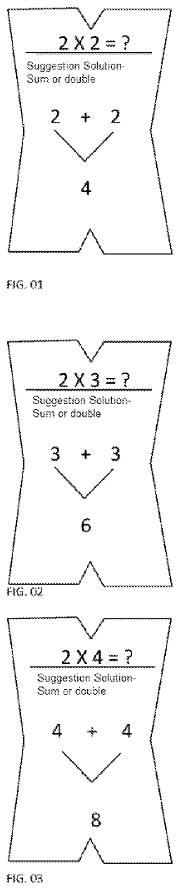

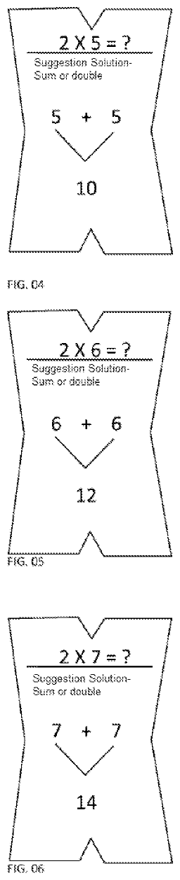

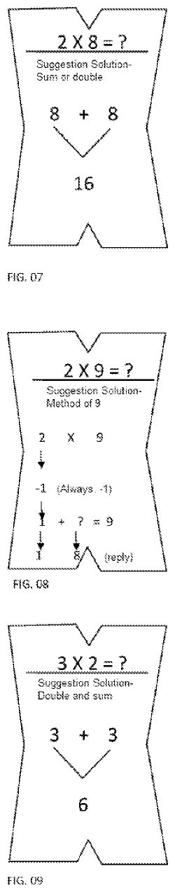

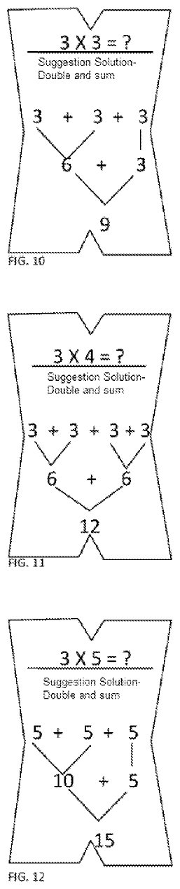

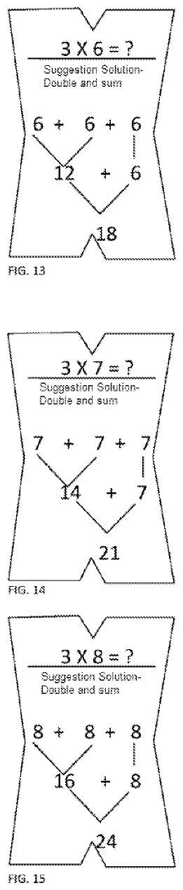

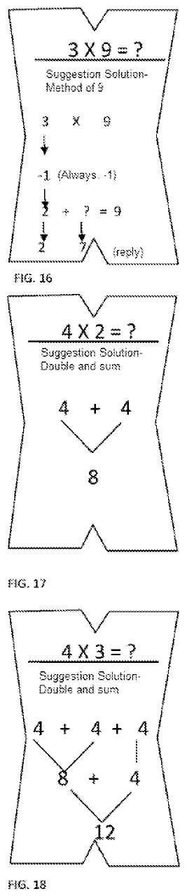

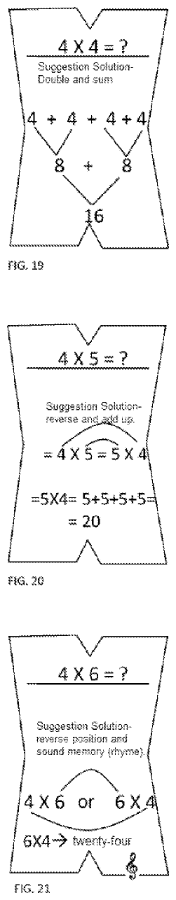

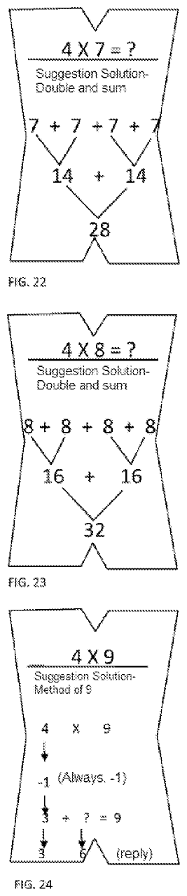

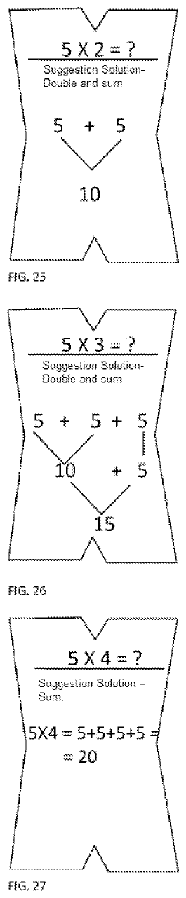

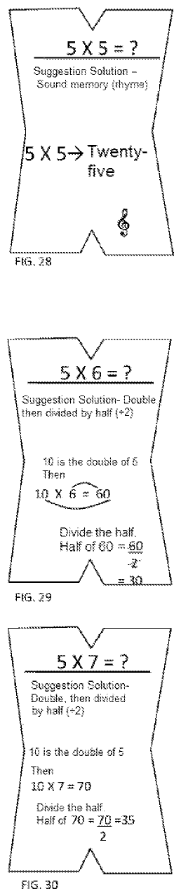

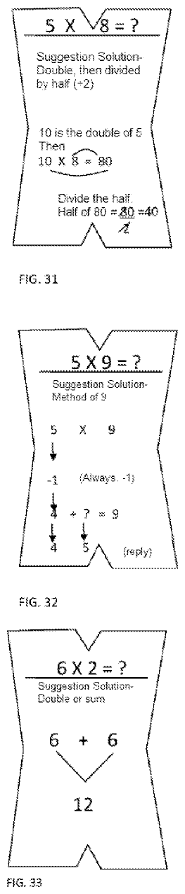

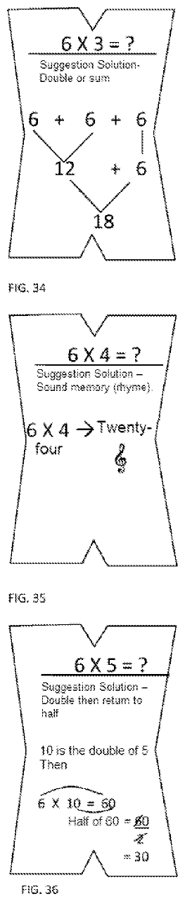

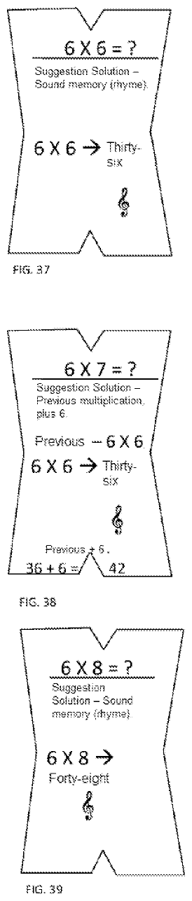

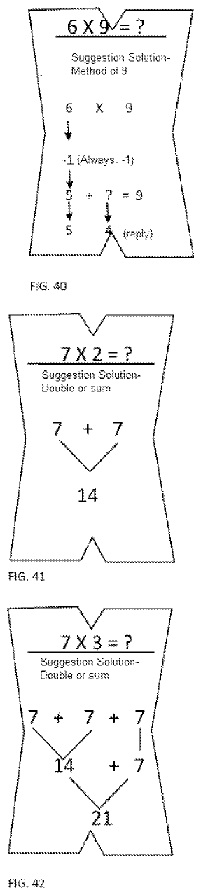

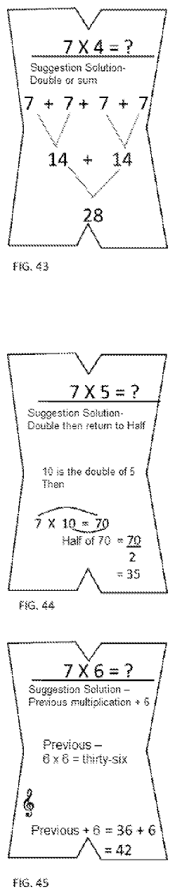

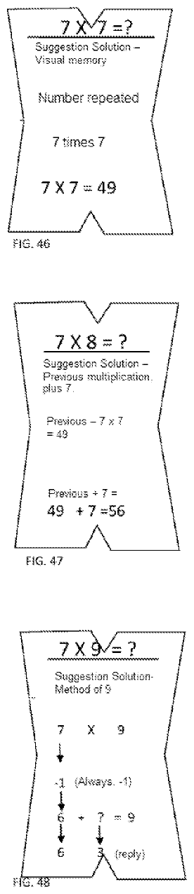

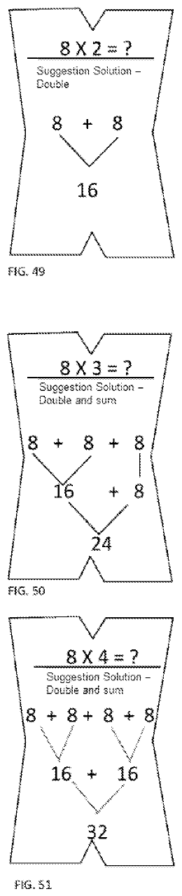

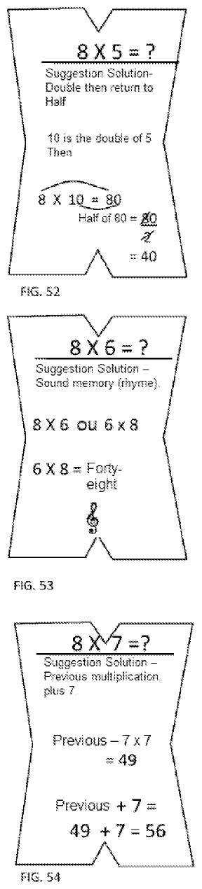

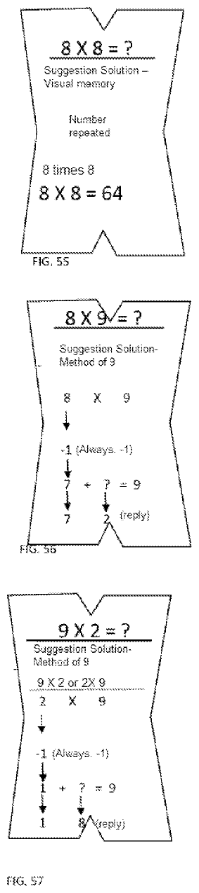

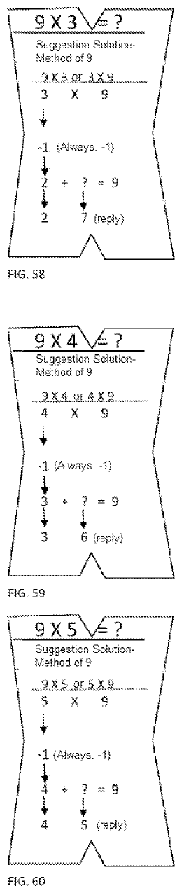

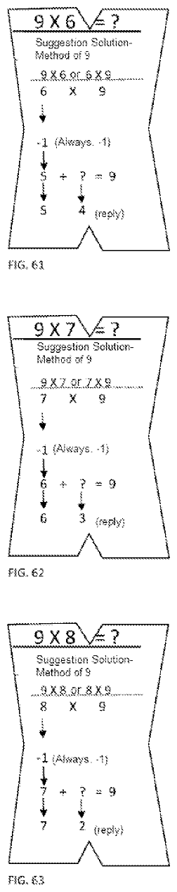

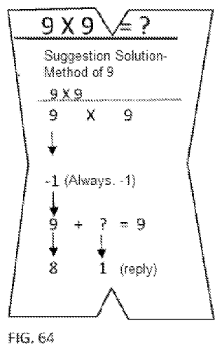

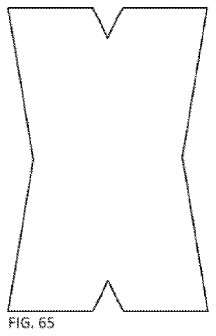

The present application for patent of invention TIMES TABLE CARD GAME refers to a board game, with cards, for two or more people. Suggested for children between 6 and 11 years old, the age range for learning the times tables at school. Students usually learn the times tables by heart. However, the game encourages children to solve the times table through mental calculation. Accordingly, even if the player or student has forgotten the result of the times table multiplication from group number 2 up to group number 9, he or she may mentally solve the multiplication. There are 64 cards. Each card has in the upper part a multiplication between numbers 2 to 9. Each card also has, beneath the upper line, information suggesting the solution to the multiplication contained in the upper line. The drawings on the 64 cards show this information, the multiplication to be asked during the game and the solution that was suggested for the asking player to see the solution and subsequently when asked, use the solution that was suggested. The players define a time for each question, in accordance with the rules of the game. Two or more people can play.

### RULES OF THE GAME

The aim of the game is to get the most questions right. Whoever gets most right wins. To play, each player draws a card from the pile that was shuffled and asks the other player(s) what the result is of the multiplication that is in the upper part of the card drawn. A timer can be used to mark the standard time for answering. For example, 3 seconds, 5 seconds or 10 seconds. If nobody gets the right result within the defined time, then the card sorted goes to the bottom of the pile of the game cards. If somebody answers correctly, he or she keeps the card for the count at the end of the game of the total amount of right answers. The player asking the question of the result of the multiplication shall check the solution for his or her future use. Put otherwise, he/she gives the right answer, when asked. The player drawing the card and asking the other(s) changes in each new round. The players may choose a clockwise or counter-clockwise sequence for the next person to draw the card and pose the question. There may be a degree of difficulty. Difficulty levels of the game can be divided by age. For example, level 1—Use only the cards from the pack with times tables beginning with numbers 2, 3, 4. Level 2—Use the cards from the pack with numbers beginning with 5, 6 with the option of including the cards beginning with 2, 3, 4 in this group. Level 3—Use the cards from the pack beginning with 7, 8, 9 with the option of including the cards from groups 2, 3, 4, 5, 6.

### Game Tips

Memorize the double of a number. Double method. The player should know what the double is of the following numbers: 2=4, 4=8, 8=16, 16=32, 32=64, 3=6, 6=12, 12=24, 5=10, 15=30, 20=40, 25=50, 7=14, 14=28. Memorize using a rhyme or a combination of sounds. Sound memory method. 6×4=twenty-four. 6×8=forty-eight. 5×5=twenty-five. 6×6=thirty-six. Memorize using the method of 5. This method considers that if 10 is the double of 5, the calculation should be done with 10 instead of 5, and the result of the multiplication by 10, should be half of this multiplication. For example: 5×8. It should be changed to 10×8. Since 10 is the double of 5. In this example, the result of the multiplication is 80. Then 80 is divided by 2. So, 80=2=40. Memorize the visual method. In this method, the multiplication is of equal numbers, suggesting the solution by visual memorization. Memorize the use of the method of 9. In every multiplication with the number 9, you need to subtract 1 from the other multiplier number other than 9. This result will be added to the number that results in 9. For example: 7×9. Subtract 1 from 7. Result 6. This result, 6 will be ADDED to the number which summed up, results in the sum 9. In this case 3. So ADDING the 6 with the 3, we have the result of 63. Another example of this method of 9.5×9. Subtract 1 from 5. Result 4. This result, 4 will be ADDED to the number which summed up, results in 9. In this case 5. So ADDING the 4 with the 5, we have the result of 45.

It demystifies and makes solving the times table easy for children. THE TIMES TABLE CARD GAME is a simple game that can be used in any school or country as an incentive to learn the times tables, and it can be played at home, providing learning and leisure.

1. A times table card game, CHARACTERIZED BY comprising 64 cards with its respective rules and game tips.

2. The times table card game according to claim 1, CHARACTERIZED in that its cards each contain a multiplication of two numbers, the numbers used in the game are 2, 3, 4, 5, 6, 7, 8 and 9, each of these numbers is individually multiplied by the numbers 2, 3, 4, 5, 6, 7, 8, 9, as in the times tables.

3. The times table card game according to claim 2, CHARACTERIZED in that each card contains a multiplication with two numbers and its respective suggested solution, the rules of the game are objective and simple, both for children and for adults.

4. The times table card game according to claim 3, CHARACTERIZED in that each card contains on the first line a multiplication question, beneath the first line, on each card, there is a suggested solution, the suggested solutions use methods such as the double of a number, the sum of small numbers, the rhyme or sonority of multiplying two numbers, the visual memory of two equal numbers multiplied, the calculation method of multiplying with the number 9, some cards have the solution of the multiplication with the use of two methods, for example, the double method and the sum method.
